(19) United States
(12) Patent Application Publication
(10) Pub. No.: US 2009/0279467 A1
(43) Pub. Date: Nov. 12, 2009

(54) Adaptive and effective power saving design

(75) Inventor: Baowei Ji, Plano, TX (US)

Correspondence Address: DOCKET CLERK, P.O. DRAWER 800889, DALLAS, TX, 75380, US

(73) Assignee: Samsung Electronics Co., Ltd., Suwon-si (JP)

(21) Appl. No.: 12/381,967

(22) Filed: Mar. 18, 2009

Related U.S. Application Data
(60) Provisional application No. 61/071,650, filed on May 9, 2008.
(60) Provisional application No. 61/133,795, filed on Jul. 2, 2008.
(60) Provisional application No. 61/133,796, filed on Jul. 2, 2008.

(51) Int. Cl. H04W 52/02; H04W 72/04

(52) U.S. Cl. 370/311; 370/330

(57) ABSTRACT

A wireless communication network comprising a plurality of base stations capable of wireless communication with a plurality of mobile stations within a coverage area of the network, wherein at least one of the plurality of base stations is capable of setting a first counter and a second counter to an initial value; if the base station has downlink data ready to be transmitted to a mobile station, determining if a frequency-time grid (FTG) for the downlink data is less than or equal to a threshold; and if the base station does not have downlink data ready to be transmitted to the mobile station, increasing the first counter by one.

### CROSS-REFERENCE TO RELATED APPLICATION(S) AND CLAIM OF PRIORITY

The present application is related to U.S. Non-provisional Patent Application No. (2008.07.002.WS0), entitled “FLEXIBLE SLEEP MODE FOR ADVANCED WIRELESS SYSTEMS”, filed concurrently herewith, and which is hereby incorporated by reference into the present application as if fully set forth herein.

The present application also is related to U.S. Provisional Patent No. 61/071,650, filed May 9, 2008, entitled “ADAPTIVE AND EFFECTIVE POWER SAVING DESIGN”. Provisional Patent No. 61/071,650 is assigned to the assignee of the present application and is hereby incorporated by reference into the present application as if fully set forth herein. The present application hereby claims priority under 35 U.S.C. §119(e) to U.S. Provisional Patent No. 61/071,650.

The present application is further related to U.S. Provisional Patent No. 61/133,795, filed Jul. 2, 2008, entitled “LOW OVERHEAD SLEEP MODE FOR ADVANCED WIRELESS SYSTEMS”. Provisional Patent No. 61/133,795 is assigned to the assignee of the present application and is hereby incorporated by reference into the present application as if fully set forth herein. The present application hereby claims priority under 35 U.S.C. §119(e) to U.S. Provisional Patent No. 61/133,795.

The present application is yet further related to U.S. Provisional Patent No. 61/133,796, filed Jul. 2, 2008, entitled “FLEXIBLE SLEEP MODE FOR ADVANCED WIRELESS SYSTEMS”. Provisional Patent No. 61/133,796 is assigned to the assignee of the present application and is hereby incorporated by reference into the present application as if fully set forth herein. The present application hereby claims priority under 35 U.S.C. §119(e) to U.S. Provisional Patent No. 61/133,796.

### TECHNICAL FIELD OF THE INVENTION

The present application relates generally to power management and, more specifically, to a system and method for reducing power consumption in wireless networks.

### BACKGROUND OF THE INVENTION

Electronic communication devices require power in order to operate. In many cases, these electronic communication devices are deployed in the form of a mobile device, such as a mobile station (MS), with a battery having a limited capacity. In order to extend the operation time of a wireless device, the electronic communication device may enter a reduced power mode, sometimes referred to as a sleep mode. This sleep mode is designed to reduce the power consumption of the electronic communication device while the device is idle. The reduction of the electronic communication power consumption through a sleep mode extends the life of the battery and reduces the amount of heat produced by the device without disabling the device.

To this end, three power saving schemes are defined for sleep mode in the IEEE 802.16e standard power saving class (PSC). PSC type I is for connections of best efforts (BE) and non-real-time variable rate (NRT-VR) type application. PSC type II is for connections of unsolicited grant service (UGS) and real-time variable rate (RT-VR) type applications. PSC type III is for multicast connections as well as for management operations.

With PSC type I, sleep windows (or sleep intervals) are interleaved with listening windows (or listening intervals) of a fixed duration. If there is no traffic in either downlink (DL) or uplink (UL) as indicated by a traffic indication message, such as an MOB_TRF_IND(0) message, the sleep interval in the next discontinuous reception (DRX) cycle doubles until the sleep interval reaches a predetermined upper limit. If the Traffic_triggered_wakening_flag (TTWF) is ‘1’ (i.e., TTWF=1), the MS returns to normal operation (i.e., active mode) upon receiving an MOB_TRF_IND(1) message. The MOB_TRF_IND(1) message indicates to the MS that there is DL data traffic ready to be transmitted to the MS. If TTWF=0, power saving class is not deactivated if traffic appears. In other words, data traffic is allowed in sleep mode if TTWF=0. However, data traffic is transmitted only in listening intervals, which are of a fixed short duration. The MS also automatically returns to normal operation whenever the MS has UL data ready for transmission.

With PSC type II, all sleep windows are of the same size, and interleaved with listening windows of a fixed duration. Similar to PSC type I, the MS exits Sleep Mode when the MS needs or is instructed by a base station (BS) to do so. For PSC types I and II, the definition of sleep and listening windows and the activation of Sleep Mode require sending MAC messages (e.g., MS initiated MOB_SLP-REQ or (bandwidth request) BR and UL Sleep Control; and BS initiated MOB_SLP-RSP or DL Sleep Control Extended Subheader). The deactivation of Sleep Mode requires a BS to send an MOB_TRF-IND with a positive indicator when TTWF=1. Alternatively, MAC message RNG-REQ also can be used to define, activate and deactivate Sleep Mode as well.

With PSC type III, signaling methods for defining and activating sleep window are the same as PSC types I and II. The difference is that the deactivation of Sleep Mode occurs automatically at the end of a sleep window (i.e., each sleep cycle lasts just one time period and one sleep window needs one definition/activation) with PSC type III.

Using the above power saving schemes, when TTWF=1, the MS has to leave sleep mode for data traffic delivery regardless if the data traffic is for DL or UL. For light bursty traffic, the MS may go back and forth between active mode and sleep mode frequently. This results in a significant exchange of MOB_SLP_REQ/RSP messages (i.e., a high signaling overhead).

When TTWF=0, the MS could receive data without leaving sleep mode. However, the disadvantage is that the MS can only receive data in the listening interval. Consequently, the remaining data has to be transmitted in the following listening intervals. Moreover, the sleep interval still doubles even though there is positive traffic indication.

Thus, the above power saving operations are more concerned with packet latency than power saving performance in sleep mode as the definition, activation, deactivation and reactivation of discontinuous reception (DRX) are all driven by signaling. Accordingly, a significant amount of signaling overhead would be invoked if a power saving configuration were to adapt to changing MS traffic pattern and activity level using the above power saving operations. This high signaling overhead requires considerable power to maintain the sleep state of the traditional communication system. As a consequence, this high signaling overhead requires considerable power and has a corresponding drain upon the battery life of the device.

Another power saving scheme proposes the use of counters C1_{MS} and C1_{BS} in the MS and BS, respectively, which are set to zero at the time the MS enters sleep mode. The counters keep track of the number of consecutive DRX cycles during which the MS does or does not receive data from the BS. If the counters count up to N, the MS has not received any data from the BS for N consecutive DRX cycles. This serves to indicate that the current DRX cycle may be smaller than it should be. In this case, the DRX cycle would be extended.

In the same scheme, counters C2_{MS} and CS_{BS} also are used by the MS and the BS, respectively. Counters C2_{MS} and CS_{BS} are set to zero at the time the MS enters sleep mode, and are used to keep track of the number of consecutive DRX cycles during which the MS does or does not receive data from the BS. If the counters count up to M, the MS has received data from the BS for M consecutive DRX cycles. This serves to indicate that the current DRX cycle may be larger than it should be. In this case, the DRX cycle would be reduced.

Although the proposed scheme attempts to reduce signaling overhead by allowing the MS to receive DL data from the BS without quitting sleep mode, the overhead issue in terms of UL transmission has not been mitigated by this proposed scheme. This is because the MS would still immediately quit sleep mode whenever there is UL data in the MS buffer ready for transmission to the BS. Moreover, even for the DL design, the proposed scheme could result in low spectral efficiency because an attempt has not been made to consider data rate adaptation for channel situations.

Accordingly, there is a need in the art for a system and method that effectively handle sleep mode to adapt to changing MS traffic pattern and activity level. In particular, there is a need for a system and method for handling sleep mode that effectively reduce power consumption by adapting to changing MS traffic pattern and activity level by taking into consideration both DL and UL data without increasing signaling overhead.

### SUMMARY OF THE INVENTION

A wireless communication network comprising a plurality of base stations capable of wireless communication with a plurality of mobile stations within a coverage area of the network, wherein at least one of the plurality of base stations is capable of setting a first counter and a second counter to an initial value; if the base station has downlink data ready to be transmitted to a mobile station, determining if a frequency-time grid (FTG) for the downlink data is less than or equal to a threshold; and if the base station does not have downlink data ready to be transmitted to the mobile station, increasing the first counter by one.

A base station capable of wireless communication with a plurality of mobile stations within a coverage area of a network, where the base station is capable of setting a first counter and a second counter to an initial value; if the base station has downlink data ready to be transmitted to a mobile station, determining if a frequency-time grid (FTG) for the downlink data is less than or equal to a threshold; and if the base station does not have downlink data ready to be transmitted to the mobile station, increasing the first counter by one.

A method of operating a base station comprising a plurality of base stations capable of wireless communication with a plurality of mobile stations within a coverage area of the network, wherein at least one of the plurality of base stations is capable of setting a first counter and a second counter to an initial value; if the base station has downlink data ready to be transmitted to a mobile station, determining if a frequency-time grid (FTG) for the downlink data is less than or equal to a threshold; and if the base station does not have downlink data ready to be transmitted to the mobile station, increasing the first counter by one.

A mobile station capable of setting a first counter and a second counter to an initial value; if the mobile station has uplink data ready to be transmitted to a base station, transmitting a bandwidth requesting message, and transmitting the uplink data; and if the mobile station does not have uplink data ready to be transmitted to a base station, doubling a next discontinuous reception (DRX) cycle if a current DRX cycle is not at a maximum DRX cycle, and moving to idle mode if a pre-defined number of previous DRX cycles have been the size of a maximum DRX cycle.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network that transmits messages in the uplink according to the principles of the present disclosure;

FIG. 2A is a high-level diagram of an OFDMA transmitter according to one embodiment of the present disclosure;

FIG. 2B is a high-level diagram of an OFDMA receiver according to one embodiment of the present disclosure;

FIG. 3 illustrates a method for reducing the signaling overhead for both DL and UL transmissions according to an embodiment of the present disclosure;

FIG. 4 illustrates a method of operating a base station according to an embodiment of the present disclosure; and

FIG. 5 illustrates a method of operating a mobile station according to an embodiment of the present disclosure.

### DETAILED DESCRIPTION OF THE INVENTION

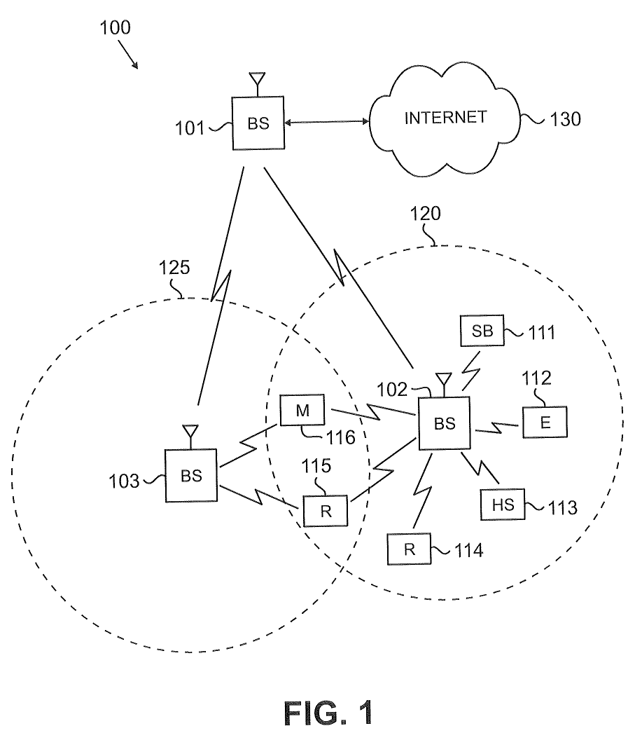

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

FIG. 1 illustrates exemplary wireless network 100, which transmits messages according to the principles of the present disclosure. In the illustrated embodiment, wireless network 100 includes base station (BS) 101, base station (BS) 102, base station (BS) 103, and other similar base stations (not shown). Base station 101 is in communication with base station 102 and base station 103. Base station 101 also is in communication with Internet 130 or a similar IP-based network (not shown).

Base station 102 provides wireless broadband access (via base station 101) to Internet 130 to a first plurality of subscriber stations within coverage area 120 of base station 102. The first plurality of subscriber stations includes subscriber station 111, which may be located in a small business (SB), subscriber station 112, which may be located in an enterprise (E), subscriber station 113, which may be located in a WiFi hotspot (HS), subscriber station 114, which may be located in a first residence (R), subscriber station 115, which may be located in a second residence (R), and subscriber station 116, which may be a mobile device (M), such as a cell phone, a wireless laptop, a wireless PDA, or the like.

Base station 103 provides wireless broadband access (via base station 101) to Internet 130 to a second plurality of subscriber stations within coverage area 125 of base station 103. The second plurality of subscriber stations includes subscriber station 115 and subscriber station 116. In an exemplary embodiment, base stations 101-103 may communicate with each other and with subscriber stations 111-116 using OFDM or OFDMA techniques.

Base station 101 may be in communication with either a greater number or a lesser number of base stations. Furthermore, while only six subscriber stations are depicted in FIG. 1, it is understood that wireless network 100 may provide wireless broadband access to additional subscriber stations. It is noted that subscriber station 115 and subscriber station 116 are located on the edges of both coverage area 120 and coverage area 125. Subscriber station 115 and subscriber station 116 each communicate with both base station 102 and base station 103 and may be said to be operating in handoff mode, as known to those of skill in the art.

Subscriber stations 111-116 may access voice, data, video, video conferencing, and/or other broadband services via Internet 130. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer (PC), a laptop computer, a gateway, or another device.

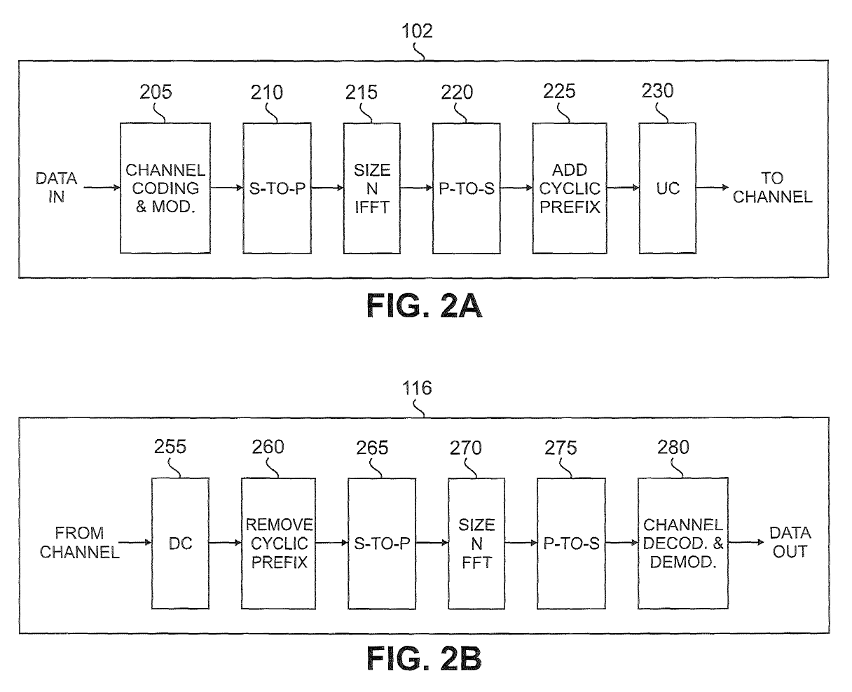

FIG. 2A is a high-level diagram of an orthogonal frequency division multiple access (OFDMA) transmit path. FIG. 2B is a high-level diagram of an orthogonal frequency division multiple access (OFDMA) receive path. In FIGS. 2A and 2B, the OFDMA transmit path is implemented in base station (BS) 102 and the OFDMA receive path is implemented in subscriber station (SS) 116 for the purposes of illustration and explanation only. However, it will be understood by those skilled in the art that the OFDMA receive path also may be implemented in BS 102 and the OFDMA transmit path may be implemented in SS 116.

The transmit path in BS 102 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. The receive path in SS 116 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2A and 2B may be implemented in software while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In BS 102, channel coding and modulation block 205 receives a set of information bits, applies coding (e.g., Turbo coding) and modulates (e.g., QPSK, QAM) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and SS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal also may be filtered at baseband before conversion to RF frequency.

The transmitted RF signal arrives at SS 116 after passing through the wireless channel and reverse operations to those at BS 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of base stations 101-103 may implement a transmit path that is analogous to transmitting in the downlink to subscriber stations 111-116 and may implement a receive path that is analogous to receiving in the uplink from subscriber stations 111-116. Similarly, each one of subscriber stations 111-116 may implement a transmit path corresponding to the architecture for transmitting in the uplink to base stations 101-103 and may implement a receive path corresponding to the architecture for receiving in the downlink from base stations 101-103.

The present disclosure discloses a system and method for handling sleep mode that effectively reduce power consumption by adapting to changing MS traffic pattern and activity level by taking into consideration both DL and UL data without increasing signaling overhead.

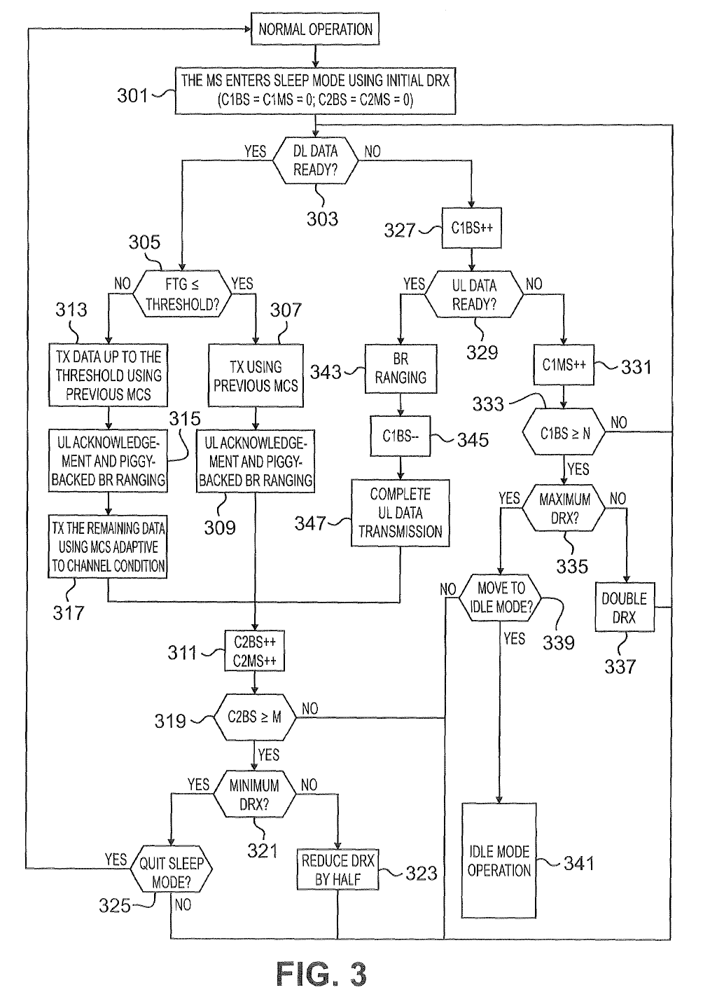

FIG. 3 illustrates a method for reducing the signaling overhead for both DL and UL transmissions according to an embodiment of the present disclosure.

As shown in FIG. 3, an MS enters sleep mode with an initial DRX period as agreed upon with a BS at Block 301. The BS has two counters for this MS, C1BS and C2BS, each set to 0. The MS also has two counters, C1MS and C2MS, each set to 0. Under proper operation, C1BS=C1MS and C2BS=C2MS.

At Block 303, the BS determines if there is DL data for the MS.

If there is DL data for the MS, the BS determines if the frequency-time grid (FTG) for the DL data is less than or equal to a certain threshold (e.g., say k subchannel-slot) at Block 305. If the frequency-time grid is less than or equal to the threshold, the BS uses the previous modulation and coding scheme (MCS) and transmits the data directly to the MS at Block 307. The MS will be assigned a dedicated UL resource for feedback acknowledgment. At Block 309, the MS transmits an acknowledgment message and piggybacks a bandwidth request with the acknowledgment message if there is UL data waiting for transmission to the BS. After the DL data has been successfully delivered, the BS increases C2BS by one, and the MS increases C2MS by one at Block 311.

If the frequency-time grid for the DL data is larger than the threshold, at Block 313, the BS uses the previous modulation and coding scheme (MCS) and transmits to the MS a portion of the data up to the threshold. The BS assigns a dedicated UL resource to the MS for transmitting an acknowledgment message as well as a piggybacked bandwidth request message. At Block 315, the MS transmits an acknowledgment message and piggybacks a bandwidth request with the acknowledgment message if there is UL data waiting for transmission to the BS. The BS then adjusts the MCS based on the channel measurements from the acknowledgment message and transmits the remaining data to the MS, together with an assigned dedicated UL resource for further acknowledgment, at Block 317. After the DL data has been successfully delivered, the BS increases C2BS by one, and the MS increases C2MS by one at Block 311.

At Block 319, the BS determines if C2BS is greater than or equal to a predetermined value M. If C2BS is greater than or equal M, the BS determines if the current DRX cycle is at the minimum DRX cycle at Block 321. If the current DRX cycle is not at the minimum DRX cycle DRX, the BS reduces the DRX cycle by half at Block 323. In this case, MS also will cut its DRX by half because the MS also compares C2MS with M and C2MS=C2BS. If the current DRX cycle is at the minimum DRX cycle, both the BS and the MS determine whether to quit sleep mode at Block 325. The MS could quit the sleep mode immediately or leave the sleep mode after operating in the minimum DRX mode for a certain number of cycles.

If there is no DL data for the MS at the beginning of the DRX cycle, the BS increases C1BS by one at Block 327.

At Block 329, the MS determines if there is UL data ready for transmission. If the MS does not have UL data ready for transmission, the MS will increase C1MS by one at Block 331.

At Block 333, the BS determines if C1BS is greater than or equal a predetermined value N. If C1BS is greater than or equal N, the BS determines if the current DRX cycle is at the maximum DRX cycle at Block 335. If the current DRX cycle is not at the maximum DRX cycle, the BS doubles DRX cycle at Block 337. In this case, MS also will double the DRX cycle because the MS also compares C1MS with N and C1MS=C2BS. If the current DRX cycle is at the maximum DRX cycle, the MS could use the maximum DRX for as many cycles as they occur. At Block 339, the MS determines whether to move to idle mode. The MS may move from sleep mode to idle mode immediately or move to idle mode after operating in the maximum DRX mode for a certain number of cycles at Block 341.

If the MS has UL data ready for transmission, at Block 343, the MS transmits a bandwidth request in contention mode if the BS has not dedicated a UL resource for the MS. In this case, the BS decreases C1BS by one at Block 345. After the MS has successfully transmitted the UL data at Block 347, the BS and the MS increase C2BS and C2MS, respectively, by one at Block 311.

If the MS does not move to idle mode, at Block 319, the BS determines if C2BS is greater than or equal to a predetermined value M. If C2BS is greater than or equal to M, the MS determines if the current DRX cycle is at the minimum DRX cycle at Block 321. If the current DRX cycle is not at the minimum DRX cycle DRX, the BS reduces the DRX cycle by half at Block 323. In this case, MS also will cut its DRX by half. If the current DRX cycle is at the minimum DRX cycle, the MS determines whether to quit sleep mode at Block 325. The MS could quit the sleep mode immediately or leave the sleep mode after operating in the minimum DRX mode for a certain number of cycles.

As shown in FIG. 3, the process repeats itself. The MS does not quit the sleep mode each time there is DL data reception. The method illustrated in FIG. 3 allows the BS to transmit the DL data effectively using the previous MCS, as well as adapting to the channel condition. Furthermore, the method of FIG. 3 does not require the MS to quit sleep mode each time the MS has UL data for transmission. The method of FIG. 3 allows the MS to transition naturally from sleep mode to idle mode or normal mode.

In some embodiments, the BS could accommodate a group of MSs using a sleep identification (SLPID)-Group. In this case, as done in IEEE 802.16e, the BS assigns an MS into a certain SLPID-Group when the MS is confirmed to enter sleep mode. However, unlike IEEE 802.16e, the MSs in one SLPID-Group could have different DRX period lengths. In some embodiments, if the DRX periods were placed in increasing order, the length of a longer period would be twice the length of the immediate shorter period. Therefore, the BS should cover all those different DRX periods, and broadcast traffic indication to the MSs when the MSs are awake.

In such an embodiment, an MS enters into the sleep mode with an initial DRX period as agreed upon with the BS. The BS has two counters for this MS, C1BS and C2BS, each set to 0. Accordingly, the MS also has two counters, C1MS and C2MS, each set to 0. Under proper operation, C1BS=C1MS and C2BS=C2MS.

At the beginning of the DRX cycle, the BS assigns one dedicated UL burst to all the MSs in a SLPID-Group to contend for bandwidth request ranging if any of those MSs need to send the request. Although the BS could dedicate more than one UL resource for those MSs to contend for bandwidth request, dedicating more than one UL resource may reduce spectrum efficiency.

At the beginning of DRX cycle, if there is DL data for an MS and if the frequency-time grid for the DL data is less than or equal to a certain threshold (e.g., say k subchannel-slot), the BS uses the previous modulation and coding scheme (MCS) and transmits the data directly to the MS. The MS will be assigned a dedicated UL resource for feedback acknowledgment. The MS also could piggyback a bandwidth request with the acknowledgment message if there is UL data ready for transmission to the BS. After the DL data has been successfully delivered, the BS increases the C2BS corresponding to the MS by one, and the MS increases its C2MS counter by one.

If the frequency-time grid is larger than the threshold, the BS uses the previous modulation and coding scheme (MCS) and transmits to the MS a portion of the data up to the threshold. The BS assigns a dedicated UL resource to the MS for transmitting an acknowledgment message as well as a piggybacked bandwidth request message. The BS then adjusts the MCS based on the channel measurement from the acknowledgment message and transmits the remaining signal to the MS, together with an assigned UL block for further acknowledgment. After the DL data has been successfully delivered, the BS increases the C2BS corresponding to the MS by one, and the MS increases its C2MS counter by one.

If C2BS is greater than or equal to M, the BS cuts the DRX for this MS by half until the DRX cycle reaches the minimum DRX. The MS also will cut its DRX by half to maintain C2BS=C2MS for this MS. If the DRX cycle reaches the minimum DRX, the MS will either quit the sleep mode immediately or leave the sleep mode after operating in the minimum DRX mode for a certain number of cycles.

At the beginning of the DRX cycle, if there is no DL data for the MS, the BS increases the C1BS corresponding to this MS by one. If the MS does not have UL data ready for transmission, the MS will increase its C1MS-counter by one also.

If C1BS is greater than or equal to N, the BS doubles the DRX cycle for this MS until the DRX cycle reaches the maximum DRX cycle. The MS also will double the DRX cycle until the DRX cycle reaches the maximum DRX cycle. If the DRX cycle reaches the maximum DRX cycle, the MS could use the maximum DRX for as many cycles as they occur. The MS also may move from the sleep mode to idle mode immediately, or the MS may move to idle mode after operating in the maximum DRX mode for a certain number of cycles.

However, if the MS has UL data, the MS will transmit a bandwidth request message in contention mode using the resource allocated by the BS for the SLPID-Group. Having identified that the MS has UL data ready for transmission, the BS decreases the C1BS counter corresponding to this MS by one. After the MS has successfully transmitted UL data, the BS and the MS increase C2BS and C2MS, respectively, by one.

If C2BS is greater than or equal to M, the BS cuts the DRX cycle for this MS by half until the DRX cycle reaches the minimum DRX cycle. The MS also will cut its DRX by half to maintain C2BS=C2MS. If DRX cycle reaches the minimum DRX cycle, the MS either quits the sleep mode immediately, or leaves the sleep mode after operating in the minimum DRX mode for a certain number of cycles.

As with the previous embodiment, this process also repeats itself. The flow chart for this process is the same as that shown in FIG. 3, except that the BS now needs to accommodate all the MSs in an SLPID-Group. In other words, the BS should cover all the different DRX periods, and broadcast traffic indication to the MSs when they are awake. Again, in this embodiment, the MS does not quit the sleep mode each time there is DL data for reception or UL data for transmission. The BS transmits the DL data effectively using the previous MCS, as well as adapts to the channel condition. The present scheme also allows the MS to transition naturally from sleep mode to idle mode or normal mode.

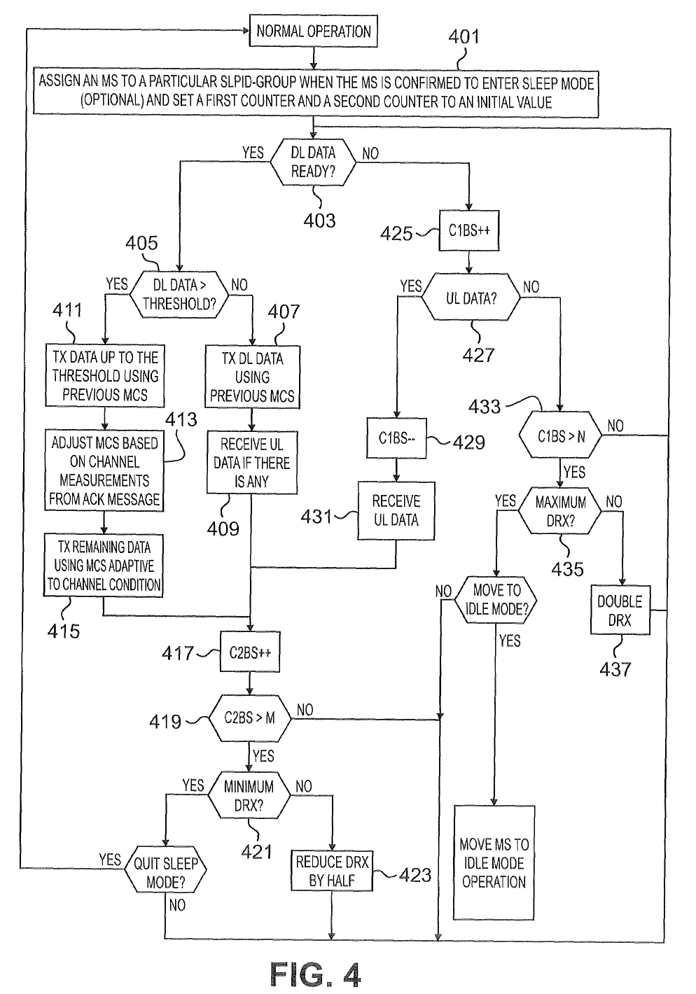

FIG. 4 illustrates a method of operating a base station according to an embodiment of the present disclosure.

As shown in FIG. 4, at Block 401, the BS assigns an MS to a particular SLPID-Group when the MS is confirmed to enter sleep mode (optional) and sets a first counter and a second counter to an initial value at Block 401. The BS determines if there is downlink data ready to be transmitted to the MS at Block 403. If there is downlink data ready to be transmitted to the MS, the BS then determines if the frequency-time grid (FTG) for the downlink data is greater than a threshold at Block 405.

If the frequency-time grid (FTG) for the downlink data is not greater than the threshold, the BS transmits the downlink data directly to the MS using the previous modulation and coding scheme (MCS) at Block 407, and receives any uplink data at Block 409. If the frequency-time grid (FTG) for the downlink data is greater than the threshold, the BS transmits an initial portion of the downlink data directly to the MS using the previous MCS up to the threshold at Block 411, adjusts the MCS based on channel measurements from an acknowledgment message received from the MS at Block 413, and transmits a remaining portion of the downlink data to the MS using the adjusted MCS at Block 415.

After successfully transmitting the downlink data, the BS increases the second counter by one at Block 417. At Block 419, the BS determines if the second counter is greater than a minimum value. If the second counter is greater than the minimum value, the BS determines if the current DRX cycle is at a minimum DRX cycle at Block 421. If the current DRX cycle is not at the minimum DRX cycle DRX, the BS reduces the DRX cycle by half at Block 423.

If the BS does not have downlink data ready to be transmitted to the MS at Block 403, the BS increases the first counter by one at Block 425. The BS determines if the MS has uplink data ready to be transmitted to the BS at Block 427. If the MS has uplink data ready to be transmitted to the BS, the BS decreases the first counter by one at Block 429, and receives the uplink data at Block 431. After successfully receiving the uplink data, the BS increases the second counter by one at Block 417. At Block 419, the BS determines if the second counter is greater than a minimum value. If the second counter is greater than the minimum value, the BS determines if the current DRX cycle is at a minimum DRX cycle at Block 421. If the current DRX cycle is not at the minimum DRX cycle DRX, the BS reduces the DRX cycle by half at Block 423.

If the MS does not have uplink data ready to be transmitted to the BS at Block 427, the BS determines if the first counter is greater than a predetermined value N at Block 433. If first counter is greater than N, the BS determines if the current DRX cycle is at a maximum DRX cycle at Block 435. If the current DRX cycle is not at the maximum DRX cycle, the BS doubles DRX cycle at Block 437.

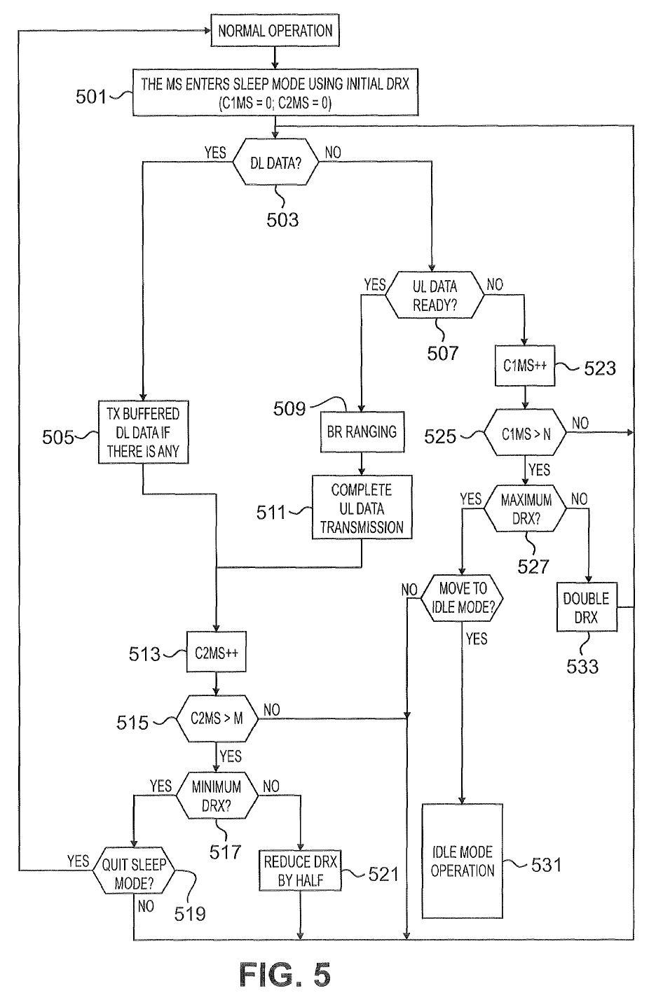

FIG. 5 illustrates a method of operating a mobile station according to an embodiment of the present disclosure.

As shown in FIG. 5, at Block 501, the MS sets a first counter and a second counter to an initial value. The MS determines if there is downlink data ready to be received from a BS at Block 503. If there is downlink data ready to be received from the BS, the MS receives the downlink data at Block 505. After successfully receiving the downlink data, the MS increases the second counter by one at Block 513. At Block 515, the MS determines if the second counter is greater than a minimum value. If the second counter is greater than the minimum value, the MS determines if the current DRX cycle is at a minimum DRX cycle at Block 517. If the current DRX cycle is at the minimum DRX cycle, the MS determines whether to quit sleep mode at Block 519. The MS could quit the sleep mode immediately or leave the sleep mode after operating in the minimum DRX mode for a certain number of cycles. If the current DRX cycle is not at the minimum DRX cycle DRX, the MS reduces the DRX cycle by half at Block 521.

If there is not any downlink data ready to be received from the BS at Block 503, the MS determines if there is any uplink data ready to be transmitted to the BS at Block 507. If there is uplink data ready to be transmitted to the BS, the MS transmits a bandwidth request message at Block 509 and transmits the uplink data at Block 511. In some embodiments, the MS piggybacks the bandwidth request with an acknowledgment message at Block 509.

Upon successfully transmitting the uplink data, the MS increases the second counter by one at Block 513. At Block 515, the MS determines if the second counter is greater than a minimum value. If the second counter is greater than the minimum value, the MS determines if the current DRX cycle is at a minimum DRX cycle at Block 517. If the current DRX cycle is at the minimum DRX cycle, the MS determines whether to quit sleep mode at Block 519. The MS could quit the sleep mode immediately or leave the sleep mode after operating in the minimum DRX mode for a certain number of cycles. If the current DRX cycle is not at the minimum DRX cycle DRX, the MS reduces the DRX cycle by half at Block 521.

If the MS determines that there is no uplink data ready to be transmitted to the BS at Block 507, the MS increases the first counter by one at Block 523. The MS determines if the first counter is greater than a predetermined value N at Block 525. If first counter is greater than N, the BS determines if the current DRX cycle is at a maximum DRX cycle at Block 527. If the current DRX cycle is at the maximum DRX cycle, the MS determines whether to move to idle mode at Block 529. The MS may move from sleep mode to idle mode immediately or move to idle mode after operating in the maximum DRX mode for a certain number of cycles at Block 531. If the current DRX cycle is not at the maximum DRX cycle, the MS doubles DRX cycle at Block 533.

Accordingly, the system and method of the present disclosure provide enhanced power saving by keeping the MS in sleep mode as much as possible, especially when there is light bursty traffic regardless of whether the traffic is DL or UL traffic.

Even though this invention does not explicitly describe the situation when the first HARQ transmission fails and retransmissions are carried out, HARQ transmissions or retransmissions will not affect the operation of the methods and systems of the present disclosure. This is because, in some embodiments, the BS and MS adjust the counters (C1BS, C1MS, C2BS and C2MS) when the data has been successfully transmitted for DL or UL, or both. In other words, the proper operation maintains C1BS=C1MS and C2BS=C2MS, so that the BS and the MS are synchronized in adaptive power saving.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A wireless communication network comprising a plurality of base stations capable of wireless communication with a plurality of mobile stations within a coverage area of the network, wherein at least one of the plurality of base stations is capable of:
setting a first counter and a second counter to an initial value;
if the base station has downlink data ready to be transmitted to a mobile station, determining if a frequency-time grid (FTG) for the downlink data is less than or equal to a threshold; and
if the base station does not have downlink data ready to be transmitted to the mobile station, increasing the first counter by one.

2. A network in accordance with claim 1 further comprising:
if the frequency-time grid (FTG) for the downlink data is less than or equal to a threshold, transmitting the downlink data directly to the mobile station using a previous modulation and coding scheme (MCS).

3. A network in accordance with claim 1 further comprising:
if the frequency-time grid (FTG) for the downlink data is not less than or equal to a threshold,
transmitting an initial portion of the downlink data directly to the mobile station using a previous modulation and coding scheme (MCS) up to the threshold,
adjusting the modulation and coding scheme based on channel measurements from an acknowledgment message received from the mobile station, and
transmitting a remaining portion of the downlink data to the mobile station using the adjusted modulation and coding scheme.

4. A network in accordance with claim 1 further comprising:
if the base station does not have downlink data ready to be transmitted to the mobile station and the mobile station does not have uplink data ready to be transmitted to the base station:
if the first counter is greater than or equal to a maximum value, doubling a next discontinuous reception (DRX) cycle if the current DRX cycle is smaller than a maximum DRX cycle.

5. A network in accordance with claim 1 further comprising:
if the base station does not have downlink data ready to be transmitted to the mobile station and the mobile station has uplink data ready to be transmitted to the base station, decreasing the first counter by one.

6. A network in accordance with claim 1 further comprising:
if the base station has downlink data ready to be transmitted to a mobile station:
increasing the second counter by one after successfully transmitting downlink data, and
if the second counter is greater than or equal to a minimum value, reducing a next discontinuous reception (DRX) cycle by half if the current DRX cycle is larger than a minimum DRX cycle.

7. A network in accordance with claim 1 further comprising:
assigning the mobile station to a particular sleep identification (SLPID)-group when the mobile station is confirmed to enter sleep mode.

8. A network in accordance with claim 1 wherein the base station accommodates all mobile stations assigned to a particular sleep identification (SLPID)-group.

9. A base station capable of wireless communication with a plurality of mobile stations within a coverage area of a network, where the base station is capable of:
setting a first counter and a second counter to an initial value;
if the base station has downlink data ready to be transmitted to a mobile station, determining if a frequency-time grid (FTG) for the downlink data is less than or equal to a threshold; and
if the base station does not have downlink data ready to be transmitted to the mobile station, increasing the first counter by one.

10. A base station in accordance with claim 9 further comprising:
if the frequency-time grid (FTG) for the downlink data is less than or equal to a threshold, transmitting the downlink data directly to the mobile station using a previous modulation and coding scheme (MCS).

11. A base station in accordance with claim 9 further comprising:
if the frequency-time grid (FTG) for the downlink data is not less than or equal to a threshold,
transmitting an initial portion of the downlink data directly to the mobile station using a previous modulation and coding scheme (MCS) up to the threshold,
adjusting the modulation and coding scheme based on channel measurements from an acknowledgment message received from the mobile station, and
transmitting a remaining portion of the downlink data to the mobile station using the adjusted modulation and coding scheme.

12. A base station in accordance with claim 9 further comprising:
if the base station does not have downlink data ready to be transmitted to the mobile station and the mobile station does not have uplink data ready to be transmitted to the base station:
if the first counter is greater than or equal to a maximum value, doubling a next discontinuous reception (DRX) cycle if the current DRX cycle is smaller than a maximum DRX cycle.

13. A base station in accordance with claim 9 further comprising:
if the base station does not have downlink data ready to be transmitted to the mobile station and the mobile station has uplink data ready to be transmitted to the base station, decreasing the first counter by one.

14. A base station in accordance with claim 9 further comprising:
if the base station has downlink data ready to be transmitted to a mobile station:
increasing the second counter by one after successfully transmitting downlink data, and
if the first counter is greater than or equal to a minimum value, reducing a next discontinuous reception (DRX) cycle by half if the current DRX cycle is larger than a minimum DRX cycle.

15. A base station in accordance with claim 9 further comprising:
assigning the mobile station to a particular sleep identification (SLPID)-group when the mobile station is confirmed to enter sleep mode.

16. A base station in accordance with claim 9 wherein the base station accommodates all mobile stations assigned to a particular sleep identification (SLPID)-group.

17. A method of operating a base station comprising:
setting a first counter and a second counter to an initial value;
if the base station has downlink data ready to be transmitted to a mobile station, determining if a frequency-time grid (FTG) for the downlink data is less than or equal to a threshold; and
if the base station does not have downlink data ready to be transmitted to the mobile station, increasing the first counter by one.

18. A method in accordance with claim 17 further comprising:
if the frequency-time grid (FTG) for the downlink data is less than or equal to a threshold, transmitting the downlink data directly to the mobile station using a previous modulation and coding scheme (MCS).

19. A method in accordance with claim 17 further comprising:
if the frequency-time grid (FTG) for the downlink data is not less than or equal to a threshold,
transmitting an initial portion of the downlink data directly to the mobile station using a previous modulation and coding scheme (MCS) up to the threshold,
adjusting the modulation and coding scheme based on channel measurements from an acknowledgment message received from the mobile station, and
transmitting a remaining portion of the downlink data to the mobile station using the adjusted modulation and coding scheme.

20. A method in accordance with claim 17 further comprising:
if the base station does not have downlink data ready to be transmitted to the mobile station and the mobile station does not have uplink data ready to be transmitted to the base station:
if the first counter is greater than or equal to a maximum value, doubling a next discontinuous reception (DRX) cycle if the current DRX cycle is smaller than a maximum DRX cycle.

21. A method in accordance with claim 17 further comprising:
if the base station does not have downlink data ready to be transmitted to the mobile station and the mobile station has uplink data ready to be transmitted to the base station, decreasing the first counter by one.

22. A method in accordance with claim 17 further comprising:
if the base station has downlink data ready to be transmitted to a mobile station:
increasing the second counter by one after successfully transmitting downlink data, and
if the first counter is greater than or equal to a minimum value, reducing a next discontinuous reception (DRX) cycle by half if the current DRX cycle is larger than a minimum DRX cycle.

23. A method in accordance with claim 17 further comprising:
assigning the mobile station to a particular sleep identification (SLPID)-group when the mobile station is confirmed to enter sleep mode.

24. A method in accordance with claim 17 wherein the base station accommodates all mobile stations assigned to a particular sleep identification (SLPID)-group.

25. A mobile station capable of:
setting a first counter and a second counter to an initial value;
if the mobile station has uplink data ready to be transmitted to a base station:
transmitting a bandwidth requesting message, and
transmitting the uplink data; and
if the mobile station does not have uplink data ready to be transmitted to a base station:
doubling a next discontinuous reception (DRX) cycle if a current DRX cycle is not at a maximum DRX cycle, and
moving to idle mode if a current DRX cycle is at a maximum DRX cycle for a pre-determined number of times.

26. A mobile station in accordance with claim 25 further comprising:
if the mobile station has uplink data ready to be transmitted to a base station:
increasing the second counter by one after successfully transmitting uplink data, and
reducing a next discontinuous reception (DRX) cycle by half if a current DRX cycle is not at a minimum DRX cycle.

27. A mobile station in accordance with claim 25 further comprising:
if the mobile station has uplink data ready to be transmitted to a base station:
increasing the second counter by one after successfully transmitting uplink data, and
quitting sleep mode immediately if a current DRX cycle is at a minimum DRX cycle for a pre-determined number of times.

28. A mobile station in accordance with claim 25 further comprising:
if the mobile station has uplink data ready to be transmitted to a base station:
increasing the second counter by one after successfully transmitting uplink data, and
quitting sleep mode after operating in a minimum DRX cycle for a certain number of cycles.

29. A mobile station in accordance with claim 25 wherein if the mobile station has uplink data ready to be transmitted to a base station, the mobile station piggybacks a bandwidth request with an acknowledgment message.

30. A mobile station in accordance with claim 25 wherein the mobile station is assigned to a particular sleep identification (SLPID)-group by the base station when the mobile station is confirmed to enter sleep mode.
